(19) United States
(12) Patent Application Publication
(10) Pub. No.: US 2010/0246838 A1
(43) Pub. Date: Sep. 30, 2010

(54) Method and Apparatus for Selecting Bass Management Filter

(75) Inventors: Steven David Trautmann, Tsukuba (JP); Akihiro Yonemoto, Tokyo (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/411,466

(22) Filed: Mar. 26, 2009

(51) Int. Cl. H04R 29/00

(52) U.S. Cl. 381/59

(57) ABSTRACT

A method and apparatus for enhancing bass management selection. The method includes retrieving a filter response for at least one filter pair, determining expected speaker and woofer spectra, calculating optimal parameters utilizing the retrieved filter response and the determined spectra, measuring flatness to determine if the result is optimal, and utilizing the determined spectra with optimal result in selecting a bass management filters for each speaker.

### BACKGROUND OF THE INVENTION

1. Field of the Invention

Embodiments of the present invention generally relate to a method and apparatus for selecting bass management filters.

2. Background of the Invention

Bass management refers to routing the low frequency part of the signal to the most effective transducer, typically a subwoofer. Usually a lower cutoff frequency is determined for the regular speaker and an upper cutoff frequency is determined for the subwoofer using methods. Frequencies below the regular loudspeaker's lower cutoff cannot be effectively reproduced by that speaker and are removed by a high pass filter chosen based on the speaker's estimated cutoff frequency. The portion of the signal below the speaker's cutoff frequency is extracted by a corresponding low-pass filter and sent to the subwoofer instead, where it can be effectively reproduced.

This high-pass low-pass filter pair can be implemented as low-order power complementary infinite-impulse response (IIR) filters with frequency responses, as shown in FIG. 1. FIG. 1 is an embodiment of a bass management power complementary filter (40 Hz cross-over). However, such a system does not take into account environmental effects and potentially the phase relationship between the woofer and speaker. Therefore, there is a need for an improved bass management filter pair selection method and apparatus.

### SUMMARY OF THE INVENTION

Embodiments of the present invention relate to a method and apparatus for enhancing bass management selection. The method includes retrieving a filter response for at least one filter pair, determining expected speaker and woofer spectra, calculating optimal parameters utilizing the retrieved filter response and the determined spectra, measuring flatness to determine if the result is optimal, and utilizing the determined spectra with optimal result in selecting a bass management filters for each speaker.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. In this application, a computer readable processor is any medium accessible by a computer for saving, writing, archiving, executing and/or accessing data. Furthermore, the method described herein may be coupled to a processing unit, wherein said processing unit is capable of performing the method.

FIG. 1 is an embodiment of a bass management power complementary filters;

FIG. 2 is an embodiment of a bass management filter selection;

FIG. 3 is an embodiment of a front left loudspeaker measured spectrum;

FIG. 4 is a flow diagram depicting an embodiment of a method for bass management filter selection;

FIG. 5 is an embodiment of an application with optimally delayed woofer signal;

FIG. 6 is an embodiment of a woofer measured spectrum;

FIG. 7 is an embodiment of an effect of choosing different bass management filters;

FIG. 8 is an embodiment of a total variance as a function of gₛ and g_{w};

FIG. 9 is an embodiment of a fourth order function of gₛ and g_{w};

FIG. 10 is an embodiment of a four constrained critical points;

FIG. 11 is an embodiment of an effect of woofer delay on critical variances;

FIG. 12 is an embodiment of an effect of woofer delay on critical variances;

FIG. 13 is an embodiment of a minimum total variance for different filter pair cross-over, with and without woofer delay; and

FIG. 14 is a flow diagram depicting an embodiment of another method for bass management filter selection.

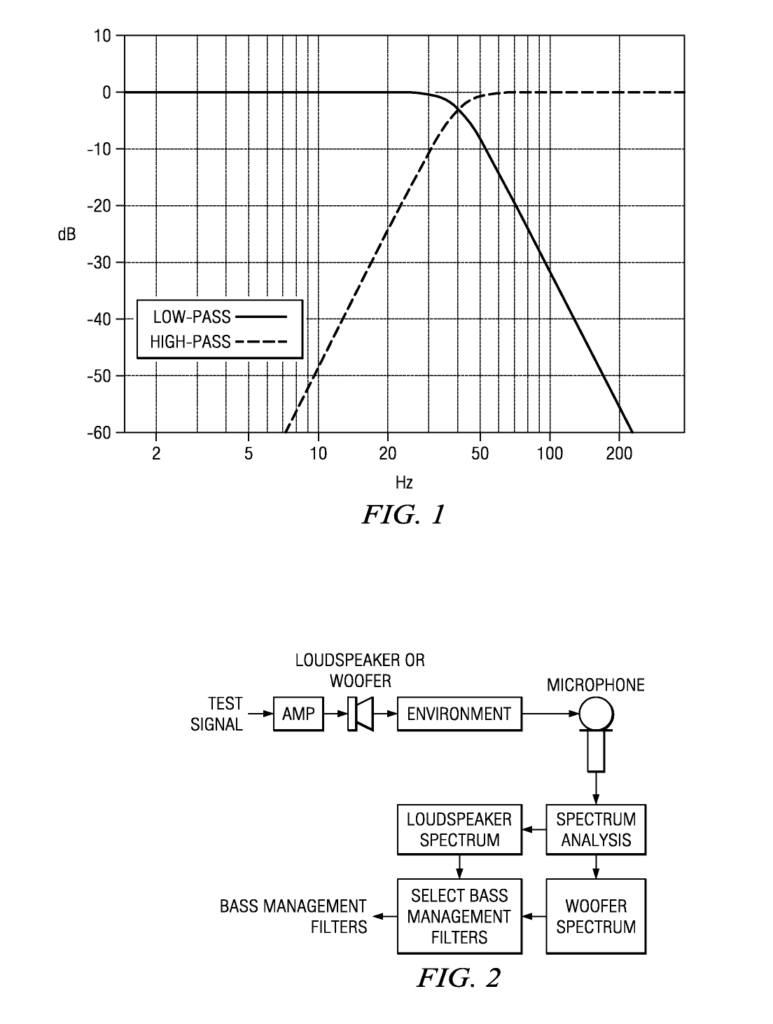

### DETAILED DESCRIPTION

Bass management, wherein an audio signal is divided between a loudspeaker and woofer, may require selection of high-pass and low-pass filters to divide the signal. Usually this is done by estimating the lower cutoff frequency of the loudspeaker. However it is also possible to select the bass management filters directly by looking at the expected response. This avoids any problem in determining the loudspeaker cutoff, takes into account the effect of the environment and potentially even the phase relationship between the woofer and speaker. Also the phase relationship can be changed by adding delay to the woofer signal. Other practical variations such as weighting functions, applying preferences and decibel (dB) scale comparisons are also discussed.

FIG. 2 is an embodiment of a bass management filter selection. FIG. 2 shows how loudspeaker and woofer measurements are taken with a microphone which determines measured spectra. Measured spectra are then used to choose appropriate bass management filters for each speaker. The measurement can be the same as the measurement used for other applications, such as, loudspeaker equalization. In loudspeaker equalization, filters may be designed to compensate for the loudspeaker responses that are applied to a signal.

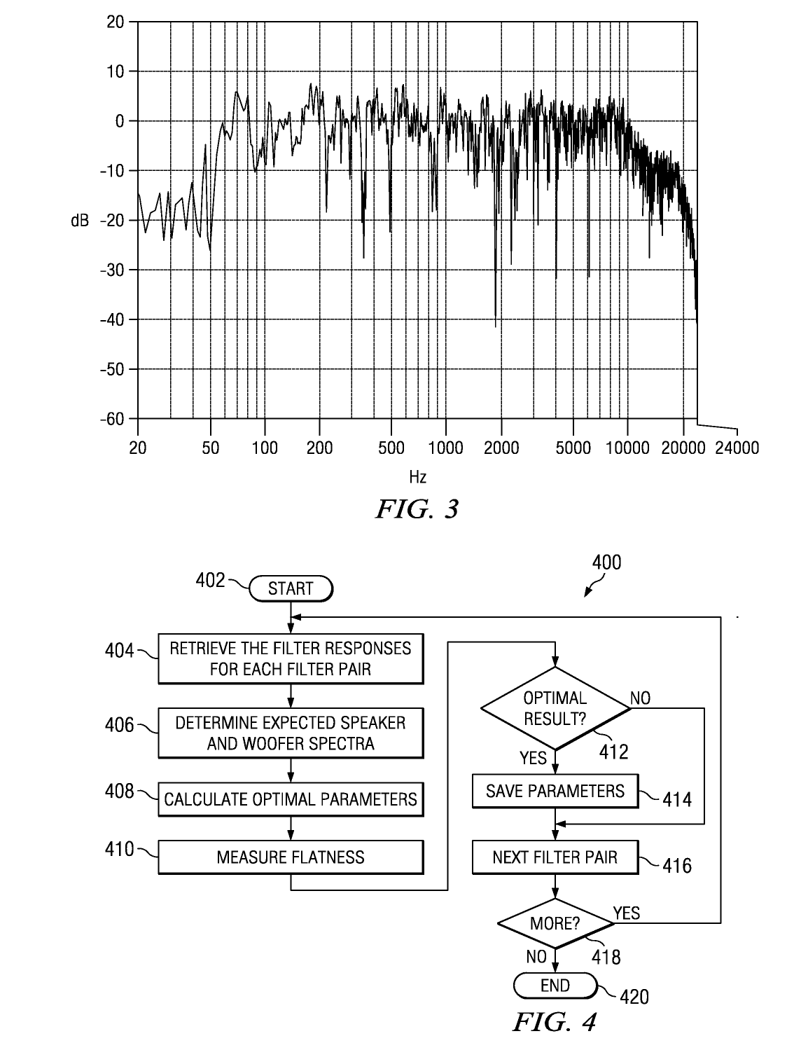

In determining the spectra, generally, a known test signal is applied to the loudspeaker and a microphone, which has a known frequency response, receives its output. The unknown system, amplifier, loudspeaker, environment, may be tested by applying a known test signal and recording the output. The frequency response may be derived using standard techniques. This measured frequency response, used primarily to design equalization filters, may be used for several addition purposes, such as, distance detection, polarity detection and cutoff detection. However, the spectrum of the measured system is typically not smooth, as shown in FIG. 3. FIG. 3 is an embodiment of a front left loudspeaker measured spectrum. Thus, the first issue is that the irregularity in the measured spectrum makes accurate cutoff estimation difficult.

A second related issue is that the spectral effects of the environment can potentially affect which filter pair produces the best result. For instance sometimes a filter pair with a higher cutoff frequency could sound better if the combined effect of speaker and environment has some problems above the speaker's cutoff frequency which the woofer can better handle. A third issue is that there will be some region where the high-pass filtered loudspeaker signal and low-pass filtered woofer signal overlap. In that cross-over region the phase relationship between loudspeaker signal and woofer signal (and listening position) determines the amplitude at those frequencies.

Three issues with selecting bass management filter based on speaker cutoff were mentioned in the introduction:
1. The difficulty in accurate estimation of loudspeaker cutoff
2. Even when the loudspeaker cutoff in known, other factors can affect which bass management filters are best
3. The interaction between the speaker and woofer signal in the crossover region.

Constraining the average magnitude to be a certain value over a certain frequency range is utilized for choosing a bass management filter pair which produces the flattest overall response. Thus, parameters are found which minimize the variance, which acts as a measure of flatness. This may be applied to all filter pairs. The filter pair that has the least variance given the constraints may be chosen. Some recommended variations are to use a frequency weighting, to penalize higher cross-over frequencies and to make final selections based on a dB scale re-evaluation.

FIG. 4 is a flow diagram depicting an embodiment of a method 400 for bass management filter selection. In FIG. 4, the basic loop followed by the proposed methods that consists of evaluating different possible bass management filters and saving the best result with its associated parameters.

Method 400 starts at step 402 and proceeds to step 404, wherein the method 400 retrieves the filter response for each filter pair. At step 406, the method 400 determines the expected speaker and woofer spectra. At step 408, the method 400 calculates optimal parameters. At step 410, the method 400 measures the flatness. If the flatness causes better results than prior itterations, the method 400 proceeds to step 414, wherein the parameters are saved and then proceeds to step 416. Otherwise, the method 400 proceeds to step 416, wherein the method 400 moves to the next filter pair for the current speaker if any remain. The method 400 proceeds to step 418. If there is more evaluation, the method 400 proceeds to step 404. Otherwise, the method 400 ends at step 420. The entire method may be repeated for additional speakers.

In one embodiment, the method addresses the first two issues by looking directly at the resulting signal, which eliminates the need to estimate cutoff frequency and includes the effects of the environment. However, such a method may not take the phase relationship between the loudspeaker and woofer into account. Instead the power from the loudspeaker and woofer is simply summed. This simplifies the computation greatly and can be used when the overlap between the high-pass and low-pass filters is small.

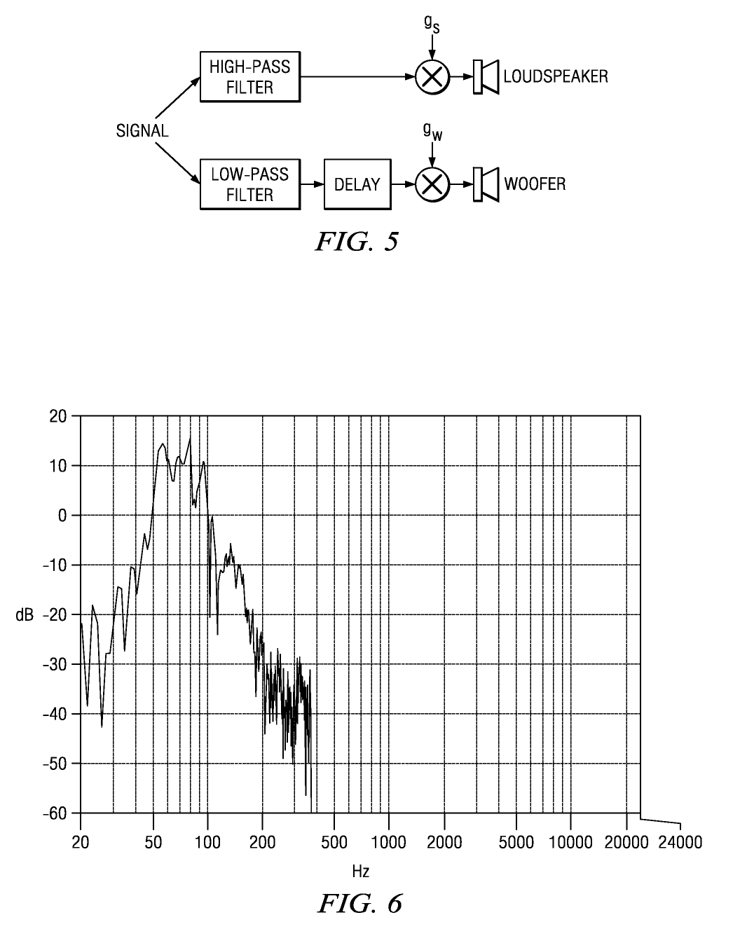

In one embodiment, the method takes the phase relationship into account, thus, dealing with the third problem. Not only is the phase relationship between the loudspeaker and woofer considered, it can also be manipulated by adding delay to the woofer signal, as shown in FIG. 5. FIG. 5 is an embodiment of an application with optimally delayed woofer signal. In FIG. 5, where gₛ refers to the speaker gain, g_{w} refers to the woofer gain, and all parameters (gₛ, g_{w}, the delay amount and which high-pass and low-pass filters are used) are determined by the method described below.

In one embodiment, the method determines and utilizes an optimal amount of delay for the bass-management woofer signal. This delay may be different from any other delay used to synchronize arrival time, and may be only used for bass management with a specific speaker in order to make the cross-over with that speaker as flat as possible.

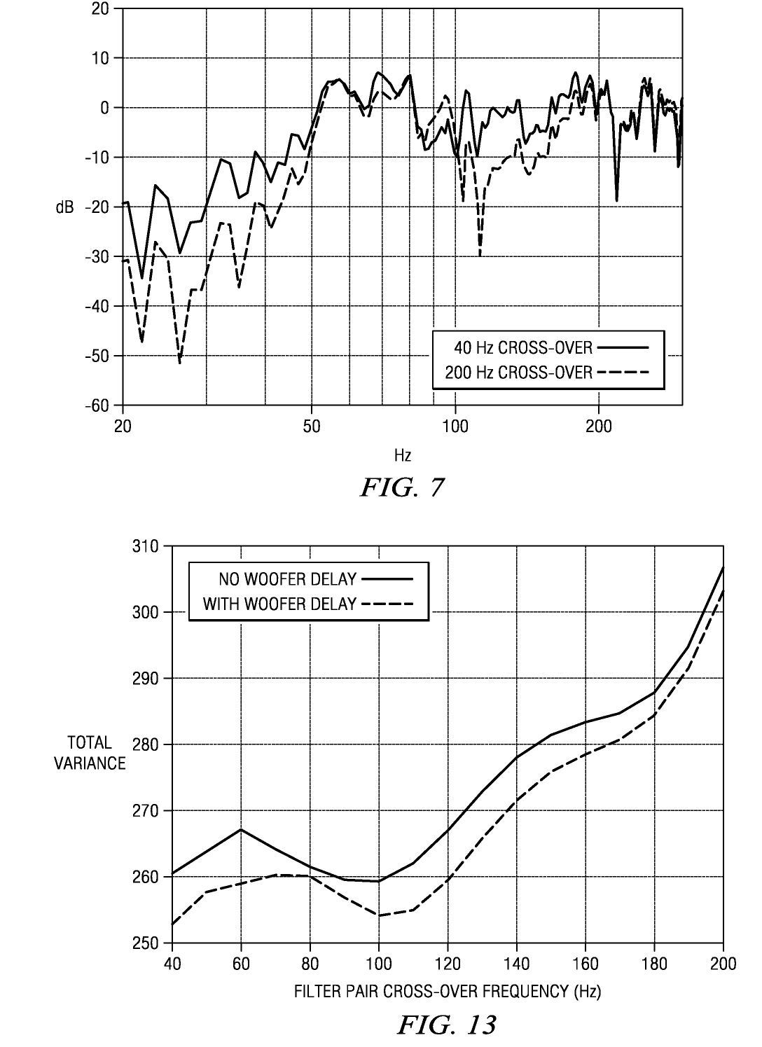

For an example, the speaker spectrum of FIG. 3 was combined with the woofer spectrum from the same speaker set shown in FIG. 6, using different bass management filters with cross-over at 40 Hz and 200 Hz, as shown in FIG. 7. FIG. 6 is an embodiment of a woofer measured spectrum. FIG. 7 is an embodiment of an effect of choosing different bass management filters.

Note that, compared to the result using cross-over filters at 40 Hz, the result using a 200 Hz cross-over filter pair produces a hole between around 100 Hz to 200 Hz. This hole is caused by overly reducing the speaker output in this range where the woofer is also weak. These holes naturally decrease the flatness of the resulting spectrum, and hence, increase the variance which can be calculated. Interestingly, since the speaker can handle frequencies into the woofer range, the 40 Hz cross-over filters also appear to decrease the large bump in the woofer spectrum without creating new holes, allowing the gain on the woofer to be increased and improving the response below 50 Hz as well.

Let S[n] be the speaker frequency response at the nth frequency bin, defined as the complex value of the speaker spectrum at the nth bin, W[n] be the woofer frequency response at the nth bin, Fₕᵢ[n] and F_{low}[n] be the frequency responses at frequency bin n of the high-pass and low-pass filters respectively. Then for some set of speaker gains gₛ and woofer gains g_{w} we can write

$${\sum }_{n = start}^{< end} ( {\vert {g}_{s} {F}_{hi} [ n ] S [ n ] \vert}^{2} + {\vert {g}_{w} {F}_{low} [ n ] W [ n ] \vert}^{2} ) = {\sum }_{n = start}^{< end} 1 \qquad ( 1 )$$

which acts as a constraint, where start and end restrict the summations to relevant frequencies, usually starting at 20 Hz and ending anywhere above the woofer response, such as 375 Hz. Among the gₛ and g_{w}, which satisfy (1) there is at least one pair of gains for which the variance is minimum, i.e.

$${\sum }_{n = start}^{< end} {( ( {\vert {g}_{s} {F}_{hi} [ n ] S [ n ] \vert}^{2} + {\vert {g}_{w} {F}_{low} [ n ] [ n ] \vert}^{2} ) - 1 )}^{2} = min \qquad ( 2 )$$

which can be thought of as representing the flattest response. In (1) and (2) only the power of the resulting signals is summed. This is reasonable when the high-pass signal and low-pass signal do not overlap much so if the filters have very sharp roll-offs, this method can be used. Simplifying notation let

sₖ²=|Fₕᵢ[k+start]S[k+start]|² (3)

wₖ²=|F_{low}[k+start]W[k+start]|² (4)

N=end−start (5)

ĝₛ=gₛ² (6)

ĝ_{w}=g_{w}² (7)

Then the constraint is simply

$${\hat{g}}_{s} {\sum }_{k = 0}^{N - 1} {s}_{k}^{2} + {\hat{g}}_{w} {\sum }_{k = 0}^{N - 1} {w}_{k}^{2} = N \qquad ( 8 )$$

and the minimization objective is

$${\sum }_{k = 0}^{N - 1} {( ( {\hat{g}}_{s} {s}_{k}^{2} + {\hat{g}}_{w} {w}_{k}^{2} ) - 1 )}^{2} = min \qquad ( 9 )$$

Solving for the speaker gain, let

$$\begin{matrix}{Λ}_{0} = {\sum }_{k = 0}^{N - 1} {s}_{k}^{2} & ( 10 ) \\ {C}_{0} = {\sum }_{k = 0}^{N - 1} {w}_{k}^{2} & ( 11 )\end{matrix}$$

so that

ĝₛA₀+ĝ_{w}C₀=N. (12)

### Then

$${\hat{g}}_{s} = \frac{N - {\hat{g}}_{w} {C}_{0}}{{A}_{0}} \qquad ( 13 )$$

Next to minimize

$${\sum }_{k = 0}^{N - 1} {( ( {\hat{g}}_{s} {s}_{k}^{2} + {\hat{g}}_{w} {w}_{k}^{2} ) - 1 )}^{2} = min$$

we let take the derivative with respect to ĝ_{w} and set equal to zero as

$$\frac{\partial }{\partial {\hat{g}}_{w}} ( {\sum }_{k = 0}^{N - 1} {( ( {\hat{g}}_{s} {s}_{k}^{2} + {\hat{g}}_{w} {w}_{k}^{2} ) - 1 )}^{2} ) = 0. \qquad ( 14 )$$

Substituting for ĝₛ in (14) using (13) gives

$$\frac{\partial }{\partial {\hat{g}}_{w}} ( {\sum }_{k = 0}^{N - 1} {( \frac{N - {\hat{g}}_{w} {C}_{0}}{{A}_{0}} {s}_{k}^{2} + {\hat{g}}_{w} {w}_{k}^{2} - 1 )}^{2} ) = 0$$

and taking the derivative

$$2 {\sum }_{k = 0}^{N - 1} ( \frac{N - {\hat{g}}_{w} {C}_{0}}{{A}_{0}} {s}_{k}^{2} + {\hat{g}}_{w} {w}_{k}^{2} - 1 ) ( \frac{- {C}_{0}}{{A}_{0}} {s}_{k}^{2} + {w}_{k}^{2} ) = 0$$

we have

$${\sum }_{k = 0}^{N - 1} ( ( \frac{N {s}_{k}^{2}}{{A}_{0}} - 1 ) - {\hat{g}}_{w} ( \frac{{C}_{0}}{{A}_{0}} {s}_{k}^{2} - {w}_{k}^{2} ) ) ( \frac{- {C}_{0}}{{A}_{0}} {s}_{k}^{2} + {w}_{k}^{2} ) = 0$$

so that

$${\hat{g}}_{w} = \frac{{\sum }_{k = 0}^{N - 1} ( \frac{N {s}_{k}^{2}}{{A}_{0}} - 1 ) ( \frac{- {C}_{0}}{{A}_{0}} {s}_{k}^{2} + {w}_{k}^{2} )}{{\sum }_{k = 0}^{N - 1} ( \frac{{C}_{0}}{{A}_{0}} {s}_{k}^{2} - {w}_{k}^{2} ) ( \frac{- {C}_{0}}{{A}_{0}} {s}_{k}^{2} + {w}_{k}^{2} )}$$

after which the variance can be calculated for each filter pair

$$var = {\sum }_{k = 0}^{N - 1} {( ( {\hat{g}}_{s} {s}_{k}^{2} + {\hat{g}}_{w} {w}_{k}^{2} ) - 1 )}^{2} .$$

The filter pair with the lowest variance is then chosen, along with corresponding positive gains gₛ=\sqrt{ĝₛ} and g_{w}=\sqrt{ĝ_{w}} for the speaker and woofer, respectively. The relative woofer gain can be found by dividing g_{w} by gₛ.

In another embodiment, the method also accounts for phase. In such a method, let S[n] be the speaker frequency response at the nth frequency bin, W[n] be the woofer frequency response at the nth bin, Fₕᵢ[n] and F_{low}[n] be the frequency responses at frequency bin n of the high-pass and low-pass filters, respectively. Then, for some set of real valued speaker gains gₛ and woofer gains g_{w}, we can write

$${{\sum }^{< end}}_{n - start} {\vert {g}_{s} {F}_{hi} [ n ] S [ n ] + {g}_{w} {F}_{low} [ n ] W [ n ] \vert}^{2} = {{\sum }^{< end}}_{n - start} 1 \qquad ( 15 )$$

which acts as a constraint. This constraint is similar to (1) but sums the speaker and woofer signals before squaring. Among the gₛ and g_{w} which satisfy (15) there is at least one pair of gains for which the variance is minimum, i.e.

$${{\sum }^{< end}}_{n = start} {( {\vert {g}_{s} {F}_{hi} [ n ] S [ n ] + {g}_{w} {F}_{low} [ n ] W [ n ] \vert}^{2} - 1 )}^{2} - min \qquad ( 16 )$$

which can be compared with (2). In order to take phase into account we use the following notation

sₖ=Fₕᵢ[k+start]S[k+start] (17)

wₖ=F_{low}[k+start]W[k+start] (18)

N=end−start (19)

where (17) and (18) can be compared with (3) and (4) respectively. Note especially that sₖ and wₖ are complex values. Then the constraint is

$${{\sum }^{N - 1}}_{k = 0} {\vert {g}_{s} {s}_{k} + {g}_{w} {w}_{k} \vert}^{2} = N \qquad ( 20 )$$

which can be contrasted with (8) while the minimization objective is

$${{\sum }^{N - 1}}_{k = 0} {( {\vert {g}_{s} {s}_{k} + {g}_{w} {w}_{k} \vert}^{2} - 1 )}^{2} = min \qquad ( 21 )$$

which can be compared with (9). Denoting complex conjugation with an overbar, expanding the constraint gives

$$\begin{matrix}{{\sum }^{N - 1}}_{k = 0} ( {g}_{s} {s}_{k} + {g}_{w} {w}_{k} ) \overline{( {g}_{s} {s}_{k} + {g}_{w} {w}_{k} )} = N & ( 22 ) \\ {{\sum }^{N - 1}}_{k = 0} ( {g}_{s}^{2} {s}_{k} {\overline{s}}_{k} + {g}_{s} {g}_{w} ( {s}_{k} {\overline{w}}_{k} + {\overline{s}}_{k} {w}_{k} ) + {g}_{w}^{2} {w}_{k} {\overline{w}}_{k} ) = N & ( 23 ) \\ {g}_{s}^{2} {{\sum }^{N - 1}}_{k = 0} {s}_{k} {\overline{s}}_{k} + {g}_{s} {g}_{w} {{\sum }^{N - 1}}_{k = 0} ( {s}_{k} {\overline{w}}_{k} + {\overline{s}}_{k} {w}_{k} ) + {g}_{w}^{2} {{\sum }^{N - 1}}_{k = 0} {w}_{k} {\overline{w}}_{k} = N & ( 24 )\end{matrix}$$

and letting

$$\begin{matrix}{A}_{0} = {{\sum }^{N - 1}}_{k = 0} {s}_{k} {\overline{s}}_{k} & ( 25 ) \\ {B}_{0} = {{\sum }^{N - 1}}_{k = 0} ( {s}_{k} {\overline{w}}_{k} + {\overline{s}}_{k} {w}_{k} ) & ( 26 ) \\ {C}_{0} = {{\sum }^{N - 1}}_{k = 0} {w}_{k} {\overline{w}}_{k} & ( 27 )\end{matrix}$$

we have

gₛ²A₀+gₛg_{w}B₀+g_{w}²C₀=N (28)

which can be compared to (12). Also note that the A₀ and C₀ defined in (25) and (27) are the same as those defined in (10) and (11), and that A₀, B₀ and C₀ are real numbers.

Next we expand the minimization objective function as follows:

$$\begin{matrix} {{\sum }_{k = 0}}^{N - 1} {( {\vert {g}_{s} {s}_{k} + {g}_{w} {w}_{k} \vert}^{2} - 1 )}^{2} = min & ( 29 ) \\ {{\sum }_{k = 0}}^{N - 1} {( ( {g}_{s} {s}_{k} + {g}_{w} {w}_{k} ) \overline{( {g}_{s} {s}_{k} + {g}_{w} {w}_{k} )} - 1 )}^{2} = min & ( 30 ) \\ {{\sum }_{k = 0}}^{N - 1} {( {g}_{s}^{2} {s}_{k} \overline{{s}_{k}} + {g}_{s} {g}_{w} ( {s}_{k} \overline{{w}_{k}} + \overline{{s}_{k}} {w}_{k} ) + {g}_{w}^{2} {w}_{k} \overline{{w}_{k}} - 1 )}^{2} = min & ( 31 ) \\ {{\sum }^{N - 1}}_{k = 0} ( {g}_{s}^{4} {s}_{k}^{2} {\overline{s}}_{k}^{2} + {g}_{s}^{3} {g}_{w} 2 ( {s}_{k}^{2} {\overline{s}}_{k} {\overline{w}}_{k} + {s}_{k} {\overline{s}}_{k}^{2} {w}_{k} ) + {g}_{s}^{2} {g}_{w}^{2} ( {s}_{k}^{2} {\overline{w}}_{k}^{2} + {\overline{s}}_{k}^{2} {w}_{k}^{2} + 4 {s}_{k} {\overline{s}}_{k} {w}_{k} {\overline{w}}_{k} ) + {g}_{s} {g}_{w}^{3} 2 ( {\overline{s}}_{k} {w}_{k}^{2} {\overline{w}}_{k} + {s}_{k} {w}_{k} {\overline{w}}_{k}^{2} ) + {g}_{w}^{4} {w}_{k}^{2} {\overline{w}}_{k}^{2} - 2 ( {g}_{s}^{2} {s}_{k} {\overline{s}}_{k} + {g}_{s } {g}_{w} ( {s}_{k} {\overline{w}}_{k} + {\overline{s}}_{k} {w}_{k} ) + {g}_{w}^{2} {w}_{k} {\overline{w}}_{k} ) + 1 ) = min \\ Let & ( 32 ) \\ {A}_{1} = {{\sum }^{N - 1}}_{k = 0} {s}_{k}^{2} {\overline{s}}_{k}^{2} & ( 33 ) \\ {B}_{1} = {{\sum }^{N - 1}}_{k = 0} 2 ( {s}_{k}^{2} {\overline{s}}_{k} {\overline{w}}_{k} + {s}_{k} {\overline{s}}_{k}^{2} {w}_{k} ) & ( 34 ) \\ {C}_{1} = {{\sum }^{N - 1}}_{k = 0} ( {s}_{k}^{2} {\overline{w}}_{k}^{2} + {\overline{s}}_{k}^{2} {w}_{k}^{2} + 4 {s}_{k} {\overline{s}}_{k} {w}_{k} {\overline{w}}_{k} ) & ( 35 ) \\ {D}_{1} = {{\sum }_{k = 0}}^{N - 1} 2 ( {\overline{s}}_{k} {w}_{k}^{2} {\overline{w}}_{k} + {s}_{k} {w}_{k} {\overline{w}}_{k}^{2} ) & ( 36 ) \\ {E}_{1} = {{\sum }^{N - 1}}_{k = 0} {w}_{k}^{2} {\overline{w}}_{k}^{2} . & ( 37 )\end{matrix}$$

Note that A₁, B₁, C₁, D₁ and E₁ are all real numbers. We have

gₛ⁴A₁+gₛ³g_{w}B₁+gₛ²g_{w}²C₁+gₛg_{w}³D₁+g_{w}⁴E₁−2(gₛ²A₀+gₛg_{w}B₀+g_{w}²C₀)+N=min (38)

which using (28) simplifies to

gₛ⁴A₁+gₛ³g_{w}B₁+gₛ²g_{w}²C₁+gₛg_{w}³D₁+g_{w}⁴E₁−N=min (39)

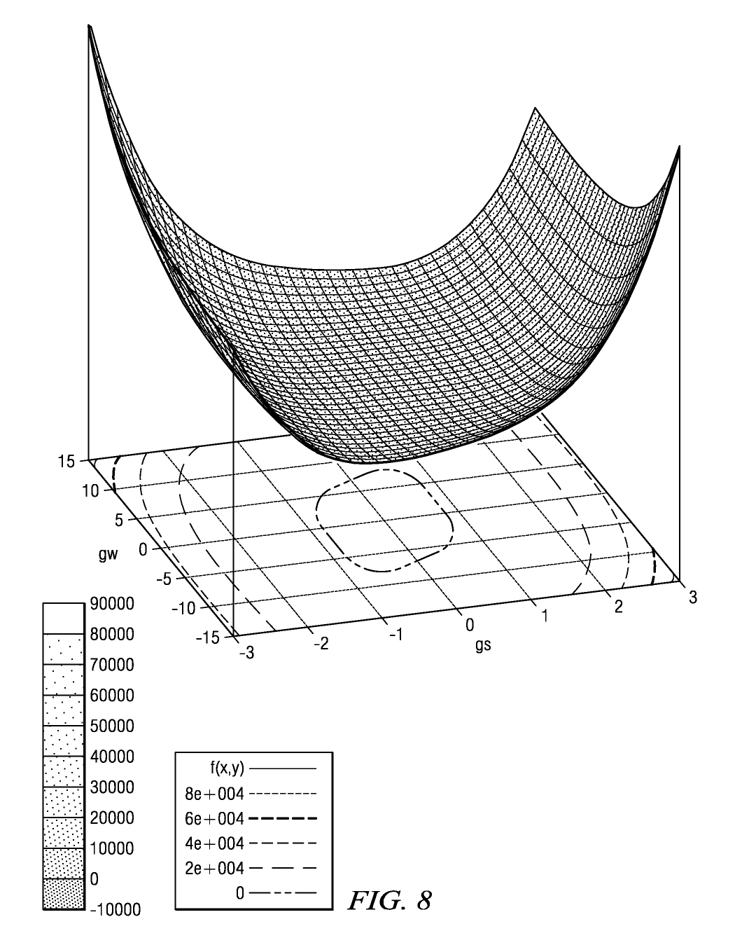

An example graph of the variance as a function of gₛ and g_{w} is given in FIG. 8. FIG. 8 is an embodiment of a total variance as a function of gₛ and g_{w}. The goal is to find the minimum variance on a constraint curve within this space utilizing Lagrange multipliers. In order to minimize

gₛ⁴A₁+gₛ³g_{w}B₁+gₛ²g_{w}²C₁+gₛg_{w}³D₁+g_{w}⁴E₁=min (40)

subject to

gₛ²A₀+gₛg_{w}B₀+g_{w}²C₀=N (41)

we try to minimize

gₛ⁴A₁+gₛ³g_{w}B₁+gₛ²g_{w}²C₁+gₛg₂³D₁+g_{w}⁴E₁−λ(gₛ²A₀+gₛg_{w}B₀+g_{w}²C₀−N)=min. (42)

Taking the partial derivative with respect to gₛ and setting equal to zero we have

$$\begin{matrix}\frac{\partial }{\partial {g}_{s}} ( {g}_{s}^{4} {A}_{1} + {g}_{s}^{3} {g}_{w} {B}_{1} + {g}_{s}^{2} {g}_{w}^{2} {C}_{1} + {g}_{s} {g}_{w}^{3} {D}_{1} + {g}_{w}^{4} {E}_{1} - λ ( {g}_{s}^{2} {A}_{0} + {g}_{s} {g}_{w} {B}_{0} + {g}_{w}^{2} {C}_{0} - N ) ) & ( 43 ) \\ = 4 {g}_{s}^{3} {A}_{1} + 3 {g}_{s}^{2} {g}_{w} {B}_{1} + 2 {g}_{s} {g}_{w}^{2} {C}_{1} + {g}_{w}^{3} {D}_{1} - λ ( 2 {g}_{s} {A}_{0} + {g}_{w} {B}_{0} ) = 0 & ( 44 )\end{matrix}$$

which gives

$$λ = \frac{4 {g}_{s}^{3} {A}_{1} + 3 {g}_{s}^{2} {g}_{w} {B}_{1} + 2 {g}_{s} {g}_{w}^{2} {C}_{1} + {g}_{w}^{3} {D}_{1}}{2 {g}_{s} {A}_{0} + {g}_{w} {B}_{0}} . \qquad ( 45 )$$

Likewise taking the partial derivative with respect to g_{w} and setting to zero

$$\begin{matrix}\frac{\partial }{\partial {g}_{w}} ( \begin{matrix}{g}_{s}^{4} {A}_{1} + {g}_{s}^{3} {g}_{w} {B}_{1} + {g}_{s}^{2} {g}_{w}^{2} {C}_{1} + {g}_{s} {g}_{w}^{3} {D}_{1} + {g}_{w}^{4} {E}_{1} - \\ λ ( {g}_{s}^{2} {A}_{0} + {g}_{s} {g}_{w} {B}_{0} + {g}_{w}^{2} {C}_{0} - N )\end{matrix} ) & ( 46 ) \\ = {g}_{s}^{3} {B}_{1} + 2 {g}_{s}^{2} {g}_{w} {C}_{1} + 3 {g}_{s} {g}_{w}^{2} {D}_{1} + 4 {g}_{w}^{3} {E}_{1} - λ ( \begin{matrix}{g}_{s} {B}_{0} + \\ 2 {g}_{w} {C}_{0}\end{matrix} ) = 0 & ( 47 )\end{matrix}$$

gives

$$λ = \frac{{g}_{s}^{3} {B}_{1} + 2 {g}_{s}^{2} {g}_{w} {C}_{1} + 3 {g}_{s} {g}_{w}^{2} {D}_{1} + 4 {g}_{w}^{3} {E}_{1}}{{g}_{s} {B}_{0} + 2 {g}_{w} {C}_{0}} . \qquad ( 48 )$$

Combining equations (45) and (48) gives

$$\begin{matrix}\frac{4 {g}_{s}^{3} {A}_{1} + 3 {g}_{s}^{2} {g}_{w} {B}_{1} + 2 {g}_{s} {g}_{w}^{2} {C}_{1} + {g}_{w}^{3} {D}_{1}}{2 {g}_{s} {A}_{0} + {g}_{w} {B}_{0}} = \frac{{g}_{s}^{3} {B}_{1} + 2 {g}_{s}^{2} {g}_{w} {C}_{1} + 3 {g}_{s} {g}_{w}^{2} {D}_{1} + 4 {g}_{w}^{3} {E}_{1}}{{g}_{s} {B}_{0} + 2 {g}_{w} {B}_{0}} & ( 49 ) \\ or & \\ ( \begin{matrix}4 {g}_{s}^{3} {A}_{1} + 3 {g}_{s}^{2} {g}_{w} {B}_{1} + \\ 2 {g}_{s} {g}_{w}^{2} {C}_{1} - {g}_{w}^{3} {D}_{1}\end{matrix} ) ( \begin{matrix}{g}_{s} {B}_{0} - \\ 2 {g}_{w} {C}_{0}\end{matrix} ) = ( \begin{matrix}{g}_{s}^{3} {B}_{1} + 2 {g}_{s}^{2} {g}_{w} {C}_{1} + \\ 3 {g}_{s} {g}_{w}^{2} {D}_{1} + 4 {g}_{w}^{3} {E}_{1}\end{matrix} ) ( \begin{matrix}2 {g}_{s} {A}_{0} + \\ {g}_{w} {B}_{0}\end{matrix} ) & ( 50 )\end{matrix}$$

and grouping terms gives

gₛ⁴(4A₁B₀−2A₀B₁)+gₛ³g_{w}(2B₀B₁+8A₁C₀−4A₀C₁)+gₛ²g_{w}²(6B₁C₀−6A₀D₁)+gₛg_{w}³(4C₀C₁−2B₀D₁−8A₀E₁)+g_{w}⁴(2C₀D₁−4B₀E₁)=0. (52)

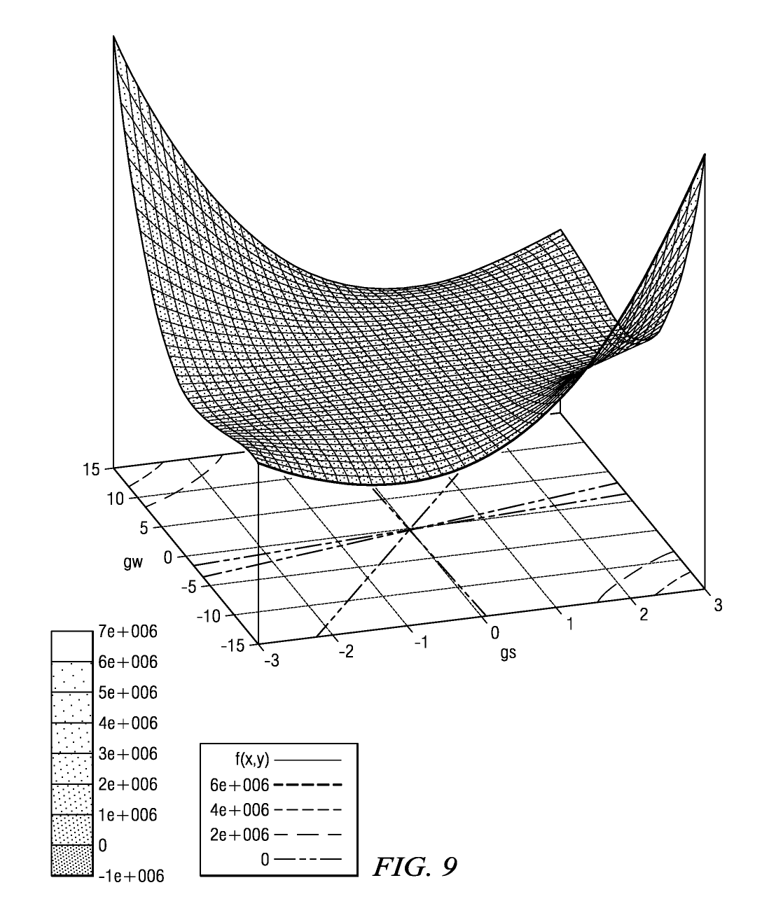

This is a fourth order polynomial and as such can be solved directly using the “Ferrari-Cardano” method. An example graph of this function based on FIG. 8 is shown in FIG. 9. FIG. 9 is an embodiment of a fourth order function of gₛ and g_{w}.

Since we want g_{w} as a function of gₛ, we can divide by (2C₀D₁−4B₀E₁) getting

$$\begin{matrix}{g}_{w}^{4} + {g}_{s} {g}_{w}^{3} \frac{4 {C}_{0} {C}_{1} - 2 {B}_{0} {D}_{1} - {8}_{0} {E}_{1}}{2 {C}_{0} {D}_{1} - 4 {B}_{0} {E}_{1}} + {g}_{s}^{2} {g}_{w}^{2} \frac{6 {B}_{1} {C}_{0} - 6 {A}_{0} {D}_{1}}{2 {C}_{0} {D}_{1} - 4 {B}_{0} {E}_{1}} & ( 53 ) \\ + {g}_{s}^{3} {g}_{w} \frac{2 {B}_{0} {B}_{1} + 8 {A}_{1} {C}_{0} - 4 {A}_{0} {C}_{1}}{2 {C}_{0} {D}_{1} - 4 {B}_{0} {E}_{1}} + {g}_{s}^{4} \frac{4 {A}_{1} {B}_{0} - 2 {A}_{0} {B}_{1}}{2 {C}_{0} {D}_{1} - 4 {B}_{0} {E}_{1}} = 0 & ( 54 )\end{matrix}$$

and look for a solution

(g_{w}−agₛ)(g_{w}−bgₛ)(g_{w}−cgₛ)(g_{w}−dgₛ)=0 (55)

Letting gₛ=1 for the moment we find solutions x such that

(x−a)(x−b)(x−c)(x−d)=0. (56)

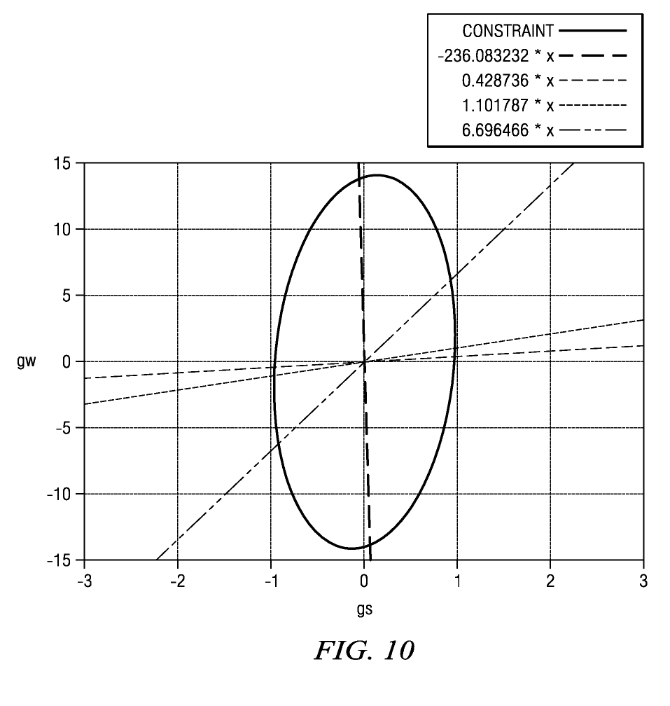

FIG. 10 is an embodiment of four constrained critical points. In FIG. 10, the roots with gₛ−1 correspond to the slopes of unconstrained solutions through the origin. To apply the constraint (28) amounts to finding the intersection of these lines with the constraint function, appearing as an ellipse. For each solution x, the linear equation is

g_{w}−xgₛ (57)

and since

gₛ²A₀+gₛg_{w}B₀+g_{w}²C₀=N (58)

gₛ²A₀+xgₛ²B₀+x²gₛ²C₀=N (59)

$$\begin{matrix}{g}_{s}^{2} = \frac{N}{{x}^{2} {C}_{0} + {xB}_{0} + {A}_{0}} & ( 60 ) \\ {g}_{s} = \sqrt{\frac{N}{{x}^{2} {C}_{0} + {xB}_{0} + {A}_{0}}} & ( 61 )\end{matrix}$$

and having gₛ we find g_{w} easily

g_{w}=xgₛ. (62)

The up to four solutions found will be the critical points of the variance which means they will be either local minimums or maximums. To find the global minimum all one may calculate the actual variance for these solutions

var=gₛ⁴A₁+gₛ³g_{w}B₁+gₛ²g_{w}C₁+gₛg_{w}³D₁g_{w}⁴E₁−N (63)

and save the solution with the lowest variance. Note sometimes g_{w} can sometimes be negative. This indicates that phase inversion applied to the woofer signal works better in the crossover region due to the relative phases of the speaker and woofer frequency responses in that region.

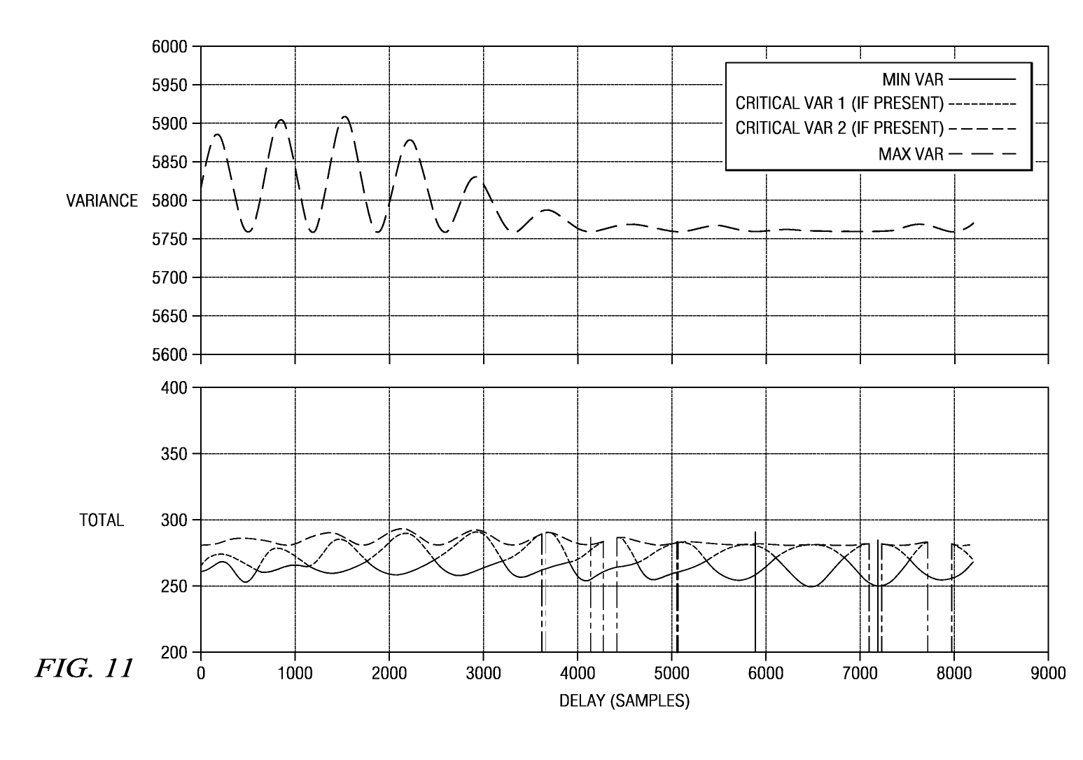

FIG. 11 is an embodiment of an effect of woofer delay on critical variances. FIG. 11 shows the way the critical variances (local maximum or minimum variances) typically behave when applying delay to the woofer. Usually, there are either 2 or 4 real roots of (55) which are affected by the phase relationship between the woofer and speaker, so changing the woofer delay affects these roots. The maximum delay is extended to 8192 samples to show how the roots behave over a large range of delay values. However in practice a large delay (more than 20 milliseconds or so) can be undesirable for psychoacoustic reasons. In FIG. 11 the minimum total variance is achieved by using a 6465 sample delay on the woofer relative to the speaker, but this corresponds to a 0.134 second delay at a 48 kHz sampling rate. The minimum variance with delay less than 0.02 seconds occurs with a 479 sample delay.

FIG. 11 also shows that the roots with the minimum variance cross each other fairly regularly. The amount of delay between these root crossings in this example is about 700 samples, which at the 48000 Hz sampling rate, is a half period of a frequency around 35 Hz, within the range affected by cross-over (the actual cross-over point for the filters is at 40 Hz in this example).

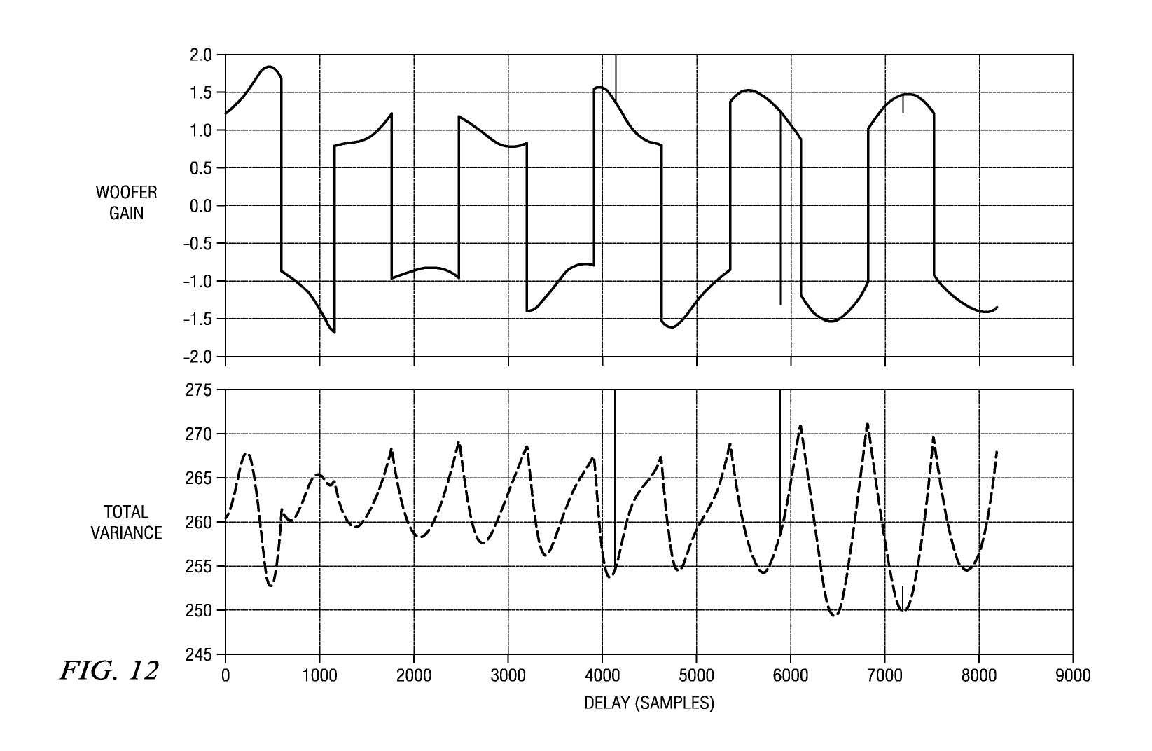

FIG. 12 is an embodiment of an effect of woofer delay on critical variances. FIG. 12 shows the minimum variance of the four roots and the corresponding relative woofer gain (with the speaker gain held constant). As shown, where there is a root crossing, the woofer gain changes polarity. The polarity change flips all the woofer frequency's phases by 180 degrees, thus putting the cross-over region back into its best alignment with the speaker frequencies. As delay further increases, the alignment (in the sense of reducing total variance) improves to a point and then gets worse, until a complete phase reversal again is needed. This pattern continues as delay is added, but since the delay affects each frequency in the cross-over region differently, the pattern is somewhat irregular.

FIG. 13 is an embodiment of a minimum total variance for different filter pair cross-over frequencies, with and without woofer delay. FIG. 13 shows the reduction in variance achieved by adding the best delay to the woofer for filters with different cross-over points, every 10 Hz from 40 Hz to 200 Hz. Also using delay, the best cross-over point for this speaker in the sense of lowest variance is at 40 Hz while without using delay the best cross-over point is at 100 Hz. Thus using delay can affect which filter pair is chosen.

Most of the calculation involved is used to find the coefficients of the polynomials. To do this efficiently, we first calculate

$$\begin{matrix}{a}_{k} = {s}_{k} {\overline{s}}_{k} & ( 64 ) \\ \begin{matrix}{b}_{k} = ( {s}_{k} {\overline{w}}_{k} + {\overline{s}}_{k} {w}_{k} ) \\ = 2 ( Re ( {s}_{k} ) Re ( {w}_{k} ) + Im ( {s}_{k} ) Im ( {w}_{k} ) )\end{matrix} & ( 65 ) \\ {c}_{k} = {w}_{k} {\overline{w}}_{k} & ( 66 ) \\ So , & \\ {A}_{0} = {\sum }_{k = 0}^{N - 1} {s}_{k} {\overline{s}}_{k} = {\sum }_{k = 0}^{N - 1} {a}_{k} & ( 67 ) \\ {B}_{0} = {\sum }_{k = 0}^{N - 1} ( {s}_{k} {\overline{w}}_{k} + {\overline{s}}_{k} {w}_{k} ) = {\sum }_{k = 0}^{N - 1} {b}_{k} & ( 68 ) \\ {C}_{0} = {\sum }_{k = 0}^{N - 1} {w}_{k} {\overline{w}}_{k} = {\sum }_{k = 0}^{N - 1} {c}_{k} & ( 69 ) \\ And & \\ {A}_{1} = {\sum }_{k = 0}^{N - 1} {s}_{k}^{2} {\overline{s}}_{k}^{2} = {\sum }_{k = 0}^{N - 1} {a}_{k}^{2} & ( 70 ) \\ {B}_{1} = {\sum }_{k = 0}^{N - 1} 2 ( {s}_{k}^{2} {\overline{s}}_{k} {\overline{w}}_{k} + {s}_{k} {\overline{s}}_{k}^{2} {w}_{k} ) = {\sum }_{k = 0}^{N - 1} 2 {a}_{k} {b}_{k} & ( 71 ) \\ {C}_{1} = {\sum }_{k = 0}^{N - 1} ( {s}_{k}^{2} {\overline{w}}_{k}^{2} + {\overline{s}}_{k}^{2} {w}_{k}^{2} + 4 {s}_{k} {\overline{s}}_{k} {w}_{k} {\overline{w}}_{k} ) = {\sum }_{k = 0}^{N - 1} ( {b}_{k}^{2} + 2 {a}_{k} {c}_{k} ) & ( 72 ) \\ {D}_{1} = {\sum }_{k = 0}^{N - 1} 2 ( {\overline{s}}_{k} {w}_{k}^{2} {\overline{w}}_{k} + {s}_{k} {w}_{k} {\overline{w}}_{k}^{2} ) = {\sum }_{k - 0}^{N - 1} 2 {c}_{k} {b}_{k} & ( 73 ) \\ {E}_{1} = {\sum }_{k = 0}^{N - 1} {w}_{k}^{2} {\overline{w}}_{k}^{2} = {\sum }_{k = 0}^{N - 1} {c}_{k}^{2} & ( 74 )\end{matrix}$$

It is also possible to change the phase relationship between the woofer and speaker by adding some delay to the woofer signal. In this case many more possibilities need to be checked. Fortunately not all the calculations need to be redone for each delay amount.

For a delay amount of n samples let

θ=πn/FFTlength (75)

so that

e^{-jπ(k+start)n/FFTlength}=e^{-j(k-start)0}^{ₙ}=cos((k+start)θₙ)−j sin((k+start)θₙ) (76)

and the woofer response at frequency bin indexed by k changes as

wₖ→wₖe^{-j(k+start)θ}^{ₙ}.

When calculating the coefficients, some are not affected by this change, in particular

$$\begin{matrix}{A}_{0} = {\sum }_{k = 0}^{N - 1} {s}_{k} {\overline{s}}_{k} & ( 77 ) \\ {A}_{1} = {\sum }_{k = 0}^{N - 1} {s}_{k}^{2} {\overline{s}}_{k}^{2} & ( 78 ) \\ {C}_{0} = {\sum }_{k = 0}^{N - 1} {w}_{k} {e}^{- j ( k + start ) {θ}_{n}} {\overline{w}}_{k} {e}^{j ( k + start ) {θ}_{n}} = {\sum }_{k = 0}^{N - 1} {w}_{k} {\overline{w}}_{k} & ( 79 ) \\ {E}_{1} = {\sum }_{k = 0}^{N - 1} {w}_{k}^{2} {e}^{- 2 j ( k + start ) {θ}_{n}} {\overline{w}}_{k}^{2} {{e}^{2}}^{j ( k + start ) {θ}_{n}} = {\sum }_{k = 0}^{N - 1} {w}_{k}^{2} {\overline{w}}_{k}^{2} & ( 80 )\end{matrix}$$

The remaining coefficients are affected by the woofer phase change.

$$\begin{matrix}{B}_{0} = {\sum }_{k = 0}^{N - 1} ( {s}_{k} {\overline{w}}_{k} {e}^{j ( k + start ) {θ}_{n}} + {\overline{s}}_{k} {w}_{k} {e}^{- j ( k + start ) {θ}_{n}} ) & ( 81 ) \\ {B}_{1} = {\sum }_{k = 0}^{N - 1} 2 ( {s}_{k}^{2} {\overline{s}}_{k} {\overline{w}}_{k} {e}^{j ( k + start ) {θ}_{n}} + {s}_{k} {\overline{s}}_{k}^{2} {w}_{k} {e}^{- j ( k + start ) {θ}_{n}} ) & ( 82 ) \\ {C}_{1} = {\sum }_{k = 0}^{N - 1} ( \begin{matrix}{s}_{k}^{2} {\overline{w}}_{k}^{2} {e}^{- j 2 ( k + start ) {θ}_{n}} + {\overline{s}}_{k}^{2} {w}_{k}^{2} {e}^{j 2 ( k + start ) {θ}_{n}} + \\ 4 {s}_{k} {\overline{s}}_{k} {w}_{k} {e}^{- j ( k + start ) {θ}_{n}} {\overline{w}}_{k} {e}^{j ( k + start ) {θ}_{n}}\end{matrix} ) & ( 83 ) \\ {D}_{1} = {\sum }_{k = 0}^{N - 1} 2 ( {\overline{s}}_{k} {w}_{k}^{2} {\overline{w}}_{k} {e}^{- j ( k + start ) {θ}_{n}} + {s}_{k} {w}_{k} {\overline{w}}_{k}^{2} {e}^{j ( k + start ) {θ}_{n}} ) & ( 84 )\end{matrix}$$

To implement these efficiently we first calculate and store in an array

aₖ=sₖ s̅ₖ (85)

\hat{b}ₖ=2(Re(sₖ)Re(wₖ)) (86)

\tilde{b}ₖ=2(Im(sₖ)Im(wₖ)) (87)

cₖ=wₖ w̅ₖ (88)

for k=0 to k=N−1 and in the same loop we can calculate

$$\begin{matrix}{A}_{0} = {\sum }_{k = 0}^{N - 1} {a}_{k} & ( 89 ) \\ {C}_{0} = {\sum }_{k = 0}^{N - 1} {c}_{k} & ( 90 ) \\ {A}_{1} = {\sum }_{k = 0}^{N - 1} {a}_{k}^{2} & ( 91 ) \\ {E}_{1} = {\sum }_{k = 0}^{N - 1} {c}_{k}^{2} & ( 92 ) \\ {\hat{C}}_{1} = {\sum }_{k = 0}^{N - 1} 2 {a}_{k} {c}_{k} . & ( 93 )\end{matrix}$$

Next, for each delay t set

θₙ=πn/FFTlength

and calculate

$$\begin{matrix}{B}_{1} = {\sum }_{k = 0}^{N - 1} 2 {a}_{k} {b}_{k} & ( 94 ) \\ {\tilde{C}}_{1} = {\sum }_{k = 0}^{N - 1} {b}_{k} {b}_{k} & ( 95 ) \\ {D}_{1} = {\sum }_{k = 0}^{N - 1} 2 {c}_{k} {b}_{k} & ( 96 ) \\ with & \\ {b}_{k} = {\hat{b}}_{k} cos ( ( k + start ) {θ}_{n} ) - {\tilde{b}}_{k} sin ( ( k + start ) {θ}_{n} ) & \end{matrix}$$

and cos((k+start)θₙ) and sin((k+start)θₙ) calculated from previous values, except for cos((start)θₙ) and sin((start)θₙ), as

$$[ \begin{matrix}cos ( ( k + start ) {θ}_{n} ) \\ sin ( ( k + start ) {θ}_{n} )\end{matrix} ] = [ \begin{matrix}cos ( {θ}_{n} ) & - sin ( {θ}_{n} ) \\ sin ( {θ}_{n} ) & cos ( {θ}_{n} )\end{matrix} ] [ \begin{matrix}cos ( ( k + start - 1 ) {θ}_{n} ) \\ sin ( ( k + start - 1 ) {θ}_{n} )\end{matrix} ] .$$

Note, however, that cos((start)θₙ) and sin((start)θₙ) can also be calculated from previous values of n in a similar way

$$[ \begin{matrix}cos ( ( start ) {θ}_{n} ) \\ sin ( ( start ) {θ}_{n} )\end{matrix} ] = [ \begin{matrix}cos ( ( start ) {θ}_{1} ) & - sin ( ( start ) {θ}_{1} ) \\ sin ( ( start ) {θ}_{1} ) & cos ( ( start ) {θ}_{1} )\end{matrix} ] [ \begin{matrix}cos ( ( start ) {θ}_{n - 1} ) \\ sin ( ( start ) {θ}_{n - 1} )\end{matrix} ] .$$

### Finally set

C₁=\tilde{C}₁+Ĉ₁

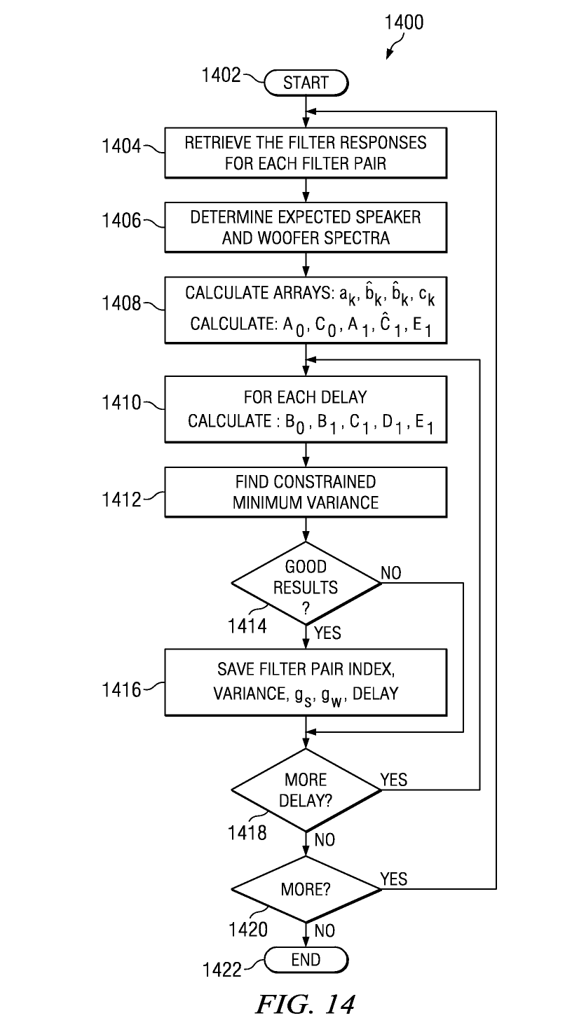

and find the minimum variance as before. If this minimum is less than the lowest minimum among the values of n tried so far, it becomes the lowest minimum and the parameters that attain this minimum, gₛ, g_{w}, n and the filter parameters, are retained replacing the previous set of best parameters. FIG. 14 is a flow diagram depicting an embodiment of another method 1400 for bass management filter selection.

Method 1400 starts at step 1402 and proceeds to step 1404, wherein the method 1400 retrieves the filter response for each filter pair. At step 1406, the method 1400 determines the expected speaker and woofer spectra. At step 1408, the method 1400 calculates parameters aₖ, bₖ, cₖ, A_{0,} C_{0,} A_{0,} C_{1,} and E₁. At step 410, the method 1400 calculates B_{0,} B_{1,} C_{1,} D₁ and E₁ for each delay. At step 1412, the method 1400 finds constrained minimum variance. At step 1414, the method 1400 determines if the results are good. If the results are better than prior results, the method 1400 proceeds to step 1416, wherein the parameters are saved and then proceeds to step 1418. Otherwise, the method 1400 proceeds to step 1418, wherein the method 1400 determines if there are more delays. If there are more delays, the method 1400 proceeds to step 1410; otherwise, the method proceeds to step 1420. At step 1420, the method 1400 determines if there are more filter pairs. If there are more filter pairs, the method 1400 proceeds to step 1404; otherwise the method 1400 proceeds to step 1422. The method 1400 ends at step 1422.

It is sometime useful to add weightings to the frequencies so that each octave has about the same relevance to overall variance as any other octave. This is simply done by applying a weight mₖ to the data sₖ and wₖ before further calculation. Letting ŝₖ=mₖsₖ and ŵₖ=mₖwₖ the constraint of the such a method becomes

$${\sum }_{k = 0}^{N - 1} {\vert {g}_{s} {\hat{s}}_{k} + {g}_{w} {\hat{w}}_{k} \vert}^{2} = N \qquad ( 97 )$$

while the minimization objective becomes

$${\sum }_{k = 0}^{N - 1} {( {\vert {g}_{s} {\hat{s}}_{k} + {g}_{w} {\hat{w}}_{k} \vert}^{2} - 1 )}^{2} = min . \qquad ( 98 )$$

Also, all else being nearly equal, lower filter pairs may be preferred in order to maximize the amount of the original signal conveyed by the intended speaker. This preference may be achieved by penalizing filter pairs with higher cross-over points. For instance, a function of the filter pair index can be added to the variance to create a composite score. The filter pair and other parameters that produce the lowest score win. Thus, the lower frequency filter cross-over are chosen unless the benefit from higher frequency filter cross-over is significant.

It may be difficult to deal with the logarithmic nature of human hearing. In order to do the calculations, a linear scale may be needed and, thus, the flatness, in terms of variance, is considered on a linear scale. However, low amplitudes can differ significantly on a decibel (dB) scale, even though a linear scale interprets such values as close to zero and not significantly different. One partial solution to this problem is to use the gain that gives minimum variance on a linear scale, but then calculate the variance on a dB scale for the purpose of making a final decision between filter pairs.

Thus, utilizing such methods for selecting bass management filters may occur without trying to determine the cutoff frequencies of the speakers involved. Instead, estimates of the effects of different high-pass/low-pass filter pairs are compared by calculating the expected variance with some weighting and choosing the filter pair, which is expected to produce the best result.

Eliminating the dependence on cutoff frequency is a big advantage since the cutoff frequency is often hard to determine, and is not the only factor in determining which bass management filters perform the best. In one embodiment, the method does not take phase into account, which can affect the result in the cross-over region. However the calculations are much simpler and if the cross-over region is not large, this method can be used. It also determines directly the gain to be applied to the woofer relative to the speaker. If, however, the cross-over region is significant, there is a risk of getting a large hole or bump in the spectrum due to interference between the woofer and speaker. Not only can the phase relationship between woofer and speaker be taken into account, it can be directly manipulated by applying a delay and/or phase inversion (negative gain) to the woofer.

In another embodiment, the method determines the best cross-over for bass management filters and best gain for the woofer relative to the speaker, while also determining the best delay to apply the woofer to improve the phase relationship between speaker and woofer in the cross-over region.

While the foregoing is directed to embodiments of the present invention, other and further embodiments of the invention may be devised without departing from the basic scope thereof, and the scope thereof is determined by the claims that follow.

What is claimed is:

1. A method for enhancing bass management selection, the method comprising:
retrieving a filter response for at least one filter pair;
determining expected speaker and woofer spectra;
calculating optimal parameters utilizing the retrieved filter response and the determined spectra;
measuring flatness to determine if the result is optimal; and
utilizing the determined spectra with optimal result in selecting a bass management filters for each speaker.

2. The method of claim 1 further comprising repeating the method to produce optimal results of the at least one filter pair.

3. The method of claim 1 further comprising changing the phase relationship between the woofer and the speaker by adding a delay to a woofer signal.

4. The method of claim 3, wherein the delay results bass management selection for a speaker making a cross-over with the speaker that is optimally flat.

5. The method of claim 3, wherein the selection of the delay is determined utilizing gₛ, speaker gain, and g_{w}, woofer gain.

6. The method of claim 3, wherein the delay improves the phase relationship between speaker and woofer in the cross-over region.

7. The method of claim 1, wherein the method accounts for at least one of phase relationship between the loudspeaker and woofer or power from the loudspeaker and woofer.

8. An apparatus for enhancing bass management selection, the method comprising:
means for retrieving a filter response for at least one filter pair;
means for determining expected speaker and woofer spectra;
means for calculating optimal parameters utilizing the retrieved filter response and the determined spectra;
means for measuring flatness to determine if the result is optimal; and
means for utilizing the determined spectra with optimal result in selecting a pair of bass management filters for each speaker.

9. The apparatus of claim 8 further comprising means for repeating the method to produce optimal results of the at least one filter pair.

10. The apparatus of claim 8 further comprising means for changing the phase relationship between the woofer and the speaker by adding a delay to a woofer signal.

11. The apparatus of claim 10, wherein the delay results in bass management selection for a speaker making a cross-over with the speaker that is optimally flat.

12. The apparatus of claim 10, wherein the selection of the delay is determined by accounting for a gₛ, speaker gain, and a g_{w}, woofer gain.

13. The apparatus of claim 10, wherein the delay improves the phase relationship between speaker and woofer in the cross-over region.

14. The apparatus of claim 8, wherein the method accounts for at least one of phase relationship between the loudspeaker and woofer or power from the loudspeaker and woofer.

15. A computer readable medium comprising software that, when executed by a processor, causes the processor to perform a method for enhancing bass management selection, the method comprising:
retrieving a filter response for at least one filter pair;
determining expected speaker and woofer spectra;
calculating optimal parameters utilizing the retrieved filter response and the determined spectra;
measuring flatness to determine if the result is optimal; and
utilizing the determined spectra with optimal result in selecting a bass management filters for each speaker.

16. The method of claim 15 further comprising repeating the method to produce optimal results of the at least one filter pair.

17. The method of claim 15 further comprising changing the phase relationship between the woofer and the speaker by adding a delay to a woofer signal.

18. The method of claim 17, wherein the delay results in bass management filter selection for a speaker and woofer making a cross-over with the speaker that is optimally flat.

19. The method of claim 17, wherein the selection of the delay is determined utilizing gₛ, speaker gain, and g_{w}, woofer gain.

20. The method of claim 17, wherein the delay improves the phase relationship between speaker and woofer in the cross-over region.

21. The method of claim 15, wherein the method accounts for at least one of phase relationship between the loudspeaker and woofer or power from the loudspeaker and woofer.
